(19) United States
(12) Patent Application Publication
(10) Pub. No.: US 2003/0187754 A1
(43) Pub. Date: Oct. 2, 2003

(54) Working endowment builder

(76) Inventor: F. Rogers Dixson JR., Atlanta, GA (US)

Correspondence Address: TECHNOPROP COLTON, L.L.C., P O BOX 567685, ATLANTA, GA, 311567685

(21) Appl. No.: 10/405,141

(22) Filed: Apr. 2, 2003

Related U.S. Application Data
(60) Provisional application No. 60/369,353, filed on Apr. 2, 2002.

(51) Int. Cl. G06F 17/60

(52) U.S. Cl. 705/26; 705/14

(57) ABSTRACT

A method for creating an endowment for an organization, institution or school by offering an equity membership that is refundable. In exchange for the membership fee, the member would be entitled to a fee and/or tuition reduction. The member has the ability to withdraw from membership, after which all or a portion of the membership fee would be refunded.

### STATEMENT OF RELATED APPLICATIONS

This patent application is based on and claims priority on U.S. Provisional Patent Application No. 60/369,353, having a filing date of Apr. 2, 2002.

### BACKGROUND OF THE INVENTION

1. Technical Field

The present invention relates generally to the field of creating and maintaining endowment and similar funds, and more specifically to the field of creating and maintaining an endowment fund using refundable contributions that provide a direct and/or indirect benefit to the contributor.

2. Prior Art.

Organizations such as schools, museums, places of worship, fraternal organizations and the like, often have a non-profit status and rely on fees for supporting day-to-day operations and both short-term and long-term programs and projects. Currently, the main sources of income for such organizations are tuition for schools, entrance fees for museums, and dues for places of worship and fraternal organizations.

Sometimes, the organization may have an endowment consisting of cash, stock, bonds, and/or property that has been donated to the organization as a source of income. Often the endowment resides as an interest-bearing corpus that is not spent, with only the interest being spent. As such, endowments often are very desirable. This is especially true for organizations such as schools that operate on a tight budget. Additionally, many charitable foundations prefer to donate money to organizations that are financially stable, and the existence of an endowment can help provide this financial stability.

### BRIEF SUMMARY OF THE INVENTION

Generally, many organizations are faced with the problem of balancing income with operating costs. Sometimes, organizations are fortunate enough to have an endowment from which funds can be drawn to cover any shortfall between income and operating costs, and to fund additional necessary or desired projects. More specifically, many schools, particularly newer schools and private schools, are faced with the problem of meeting increasing operating costs without the benefit of income from an endowment. And while most such institutions work hard to build an endowment, this is generally a long-term endeavor. For those schools that do not have sufficient endowments, funding needs increasingly have to be met through outside means (fund raising drives, etc.) and, typically as a last resort, substantial tuition increases. However, there is a downside to raising tuition.

Even more specifically, private school tuition represents a significant after tax expense for many parents. Rising tuition costs are putting private education beyond the means of many people. While in some cases the increased costs can be offset with financial aid, this puts additional pressure on an institution's already scarce resources. Also, many parents have assets that they are unable or unwilling to liquidate but that disqualify them for being considered for financial aid. This does not diminish the severity of their challenge in meeting increasing tuition costs, however. If such parents had a mechanism for reducing their tuition burden by making some of their investment resources available to a school, it could be expected that they would be interested in doing so. The following approach outlines a program for providing this mechanism to parents while simultaneously generating a “working endowment” for the school.

Briefly, the invention creates an endowment for an organization. The organization offers a type of “equity membership” that is refundable. In exchange for the membership fee, the member would be entitled to a fee reduction. At any time, or at certain designated times, the member could withdraw from membership, and all or a portion of the membership fee would be refunded. The preferred general embodiment of the invention is to create an endowment in a non-profit and/or fee-based organization and the preferred specific embodiment of the invention is to create an endowment in a school, public or more likely private, including elementary/grammar/grade schools, high schools and secondary schools, colleges and universities, and any other type of school or fee-based institution that could benefit from an endowment.

In operation, parents would “join” the school's endowment by paying a membership fee. The school could set the fee or the fee could be variable based on what the parent desires to pay. The payment leads to an ongoing annual tuition reduction. For example, for every dollar the parent pays, the parent would be given a tuition reduction for a child or grandchild who is a student at the school. The tuition reduction can be any selected amount, but it is contemplated that an annual tuition reduction in the amount of 10 to 20% of the “membership fee” could be a substantial incentive to the parent, particularly if the membership could be covered by a bond so that the member-parents would face minimal risk.

The tuition reduction would be sustained for each year that the membership was maintained. At the end of the child's attendance at the school, the membership fee, or a portion of the membership fee, would be returned to the parent. Since new students arrive as others depart every year, a continuing infusion of cash could be expected to replace the returned membership fees and potentially expand the membership base. Preferably, the membership fee return could be timed for the start of the subsequent school year so that there was no short-term shortfall.

Using this system, the parents would be able to refundably “donate” money to the school, obtain a tuition reduction for their children, and obtain a refund of the “donation” after all of their children leave the school.

As can be seen, there exists a need for a method to create a funds base for organizations or institutions without having to rely on typical donations. There is a further need for a method to create a funds base, such as an endowment, at a minimal cost to the persons providing the funds. There is a further need for a method to create an endowment that allows an infusion of money from sources other than donations, and that provide a real benefit to the persons providing the funds. It is to these and other needs that the present invention is directed.

### DETAILED DESCRIPTION OF THE PREFERRED EMBODIMENTS

The present invention is a method for creating an endowment for an organization based on the sale of a type of refundable “equity membership”. In exchange for the membership fee, the member would be entitled to a fee reduction, such as a tuition reduction for a school, an entrance fee reduction for a museum, or a dues reduction for a synagogue, church or fraternal organization. At any time, or at certain designated times, the member could withdraw from membership, and all or a portion of the membership fee would be refunded. It is contemplated that the membership fee would not be refunded until after a calendar year, fiscal year, school year or other set period of time to prevent the payment of the membership fee to obtain an immediate fee reduction, and then the withdrawal of the membership fee shortly thereafter.

A preferred general embodiment of the invention is to create an endowment in a non-profit and/or fee-based organization or institution and a preferred specific embodiment of the invention is to create an endowment in a school. Throughout this specification, the term school is used as a general term to describe all types of schools such as, but not limited to, pre, grade, elementary, grammar, middle, junior high, high, secondary, academy, post-secondary, vocational, college, university, seminary, and the like, whether private, semiprivate or public. Although the following detailed description of the preferred embodiments is made using a school as the illustrative example, the invention is not limited to schools and is applicable to many other non-profit, charitable, fee-based and other organizations and institutions.

In operation in the illustrative example of a school requiring tuition and/or other fees for students, parents would “join” the school's endowment by paying a membership fee. The school could set the fee or the fee could be variable based on what the parent desires to pay. The payment leads to an ongoing annual tuition reduction. That is, for every dollar the parent pays, the parent would be given a tuition reduction for a child or grandchild who is a student at the school. The tuition reduction can be any selected amount, but it is contemplated that an annual tuition reduction in the general amount of 0 to 50%, and more likely 10 to 20%, of the “membership fee” could be a substantial incentive to the parent.

More specifically, assume the annual tuition for the school is $10,000.00. For every $5,000.00 the parents pay as a membership fee, the parents would obtain a discount on their child's or children's' tuition. This discount can be any amount selected by the school, and it is contemplated that a feasible discount preferably would be a total of 1% to 25% of the total membership fee paid, and more preferably be 5% to 20% of the total membership fee paid. For this example, a 10% discount will be used. So, using this example, if parents pay a membership fee of $25,000.00, the parents would receive a total tuition reduction of $2,500.00 to be applied against their child's or children's' total tuition. Assuming the parents had two children in the school, rather than paying $20,000.00 in tuition, the parents would pay $17,500.00.

The tuition reduction would be sustained for each year that the membership was maintained. And, for example, at the end of the child's or children's' attendance at the school, the membership fee, or a portion of the membership fee, would be returned to the parent. Since new students arrive as others depart every year, a continuing infusion of cash could be expected to replace the returned membership fees and potentially expand the membership base. Preferably, the membership fee return could be timed for the start of the subsequent school year so that there was no short-term shortfall. Using this system, the parents would be able to refundably provide money to the school, obtain a tuition reduction for their children, and obtain a refund after all of their children leave the school.

While there is an ongoing cost in reduced tuition revenue, the overall tuition revenue decrease is offset by the much larger increase in available cash that could be used to fund programs that would otherwise require a portion of the tuition revenue. Furthermore, since there is a relatively long “pay-back” period for the “membership,” it is probable that during this time normal tuition costs would continue to rise reducing the net cost to the school. These increases could not only lead to increased tuition revenue they could present further opportunities for member-parents to reduce their tuition cost by increasing their membership level.

Besides the tuition reduction, there are other reasons a parent might be interested in this program. For instance, since there is no interest payment or other “investment” consideration involved and since there is no tax deduction for tuition payment, the tuition reduction and return of fee should be a non-taxable event. This means that the tuition reduction could be analogous to receiving a very low risk tax-free “return” on the money used to fund the membership. It is also possible that in some cases a portion, if not all, of the membership fee would be donated to the school at a student's departure (e.g., at graduation or at a family relocation). Because the fee is otherwise fully refundable to the parents, some portion, if not all, of such a donation at the student's or students' departure would probably be tax deductible by the parents at that time. Clearly a tax specialist would need to examine the particulars of this concept to verify any tax related aspects of the transaction. In any case, it is conceivable that ten to twenty percent, if not more, of the total of the membership fees would be donated rather than refunded.

There are a number of options that could be considered in setting up a program for a specific school. For instance, there may be a threshold at which the tuition reduction would adversely impact the institution. To prevent this problem, a school could decide whether to limit the fee to a maximum of some percentage of the total tuition amount or, if it was appropriate, to limit the number of “membership positions” to a percentage of the overall school population. However, since in many small and new schools a portion of the tuition is used to cover operating and other costs that would otherwise be covered by income from an endowment, it is likely that a substantial number of institutions would be interested in this approach at some level.

Additionally, the membership fees or endowment could be covered by a bond so that the member-parents would face minimal risk. Thus, if the school ceased operations, the membership could still obtain a refund of the membership fees from the bond.

In summary, this plan could have merit for a school that is willing to forego some tuition revenue for the sake of building a “working endowment”. The “working endowment” would be generated by an immediate infusion of interest free cash that was many times the value of the tuition revenue lost by the reduced fees for the member-parents. In addition to providing an immediate alternative to funding programs from tuition revenues and outside fund raising activities (which typically is a longer term process) this working endowment could provide an institution a basis on which to build a longer term more permanent endowment. And once a sufficient permanent endowment was in place, the program could either be phased out or maintained to fund additional programs such as scholarships, etc.

There are aspects of this concept that could lend themselves to either licensing or business services (such as a fee based fund management service) arrangements. Therefore, it is further contemplated that the present invention would include a system for the implementation and operation of a working endowment builder, and a business method for implementing and operating a working endowment builder.

The above description and examples set forth the best mode of the invention as known to the inventor at this time, and is for illustrative purposes only, as one skilled in the art will be able to make modifications to this process without departing from the spirit and scope of the invention and its equivalents as set forth in the appended provisional claims.

What is claimed is:

1. A method for creating an endowment for an organization charging fees comprising the steps of:
a. selling memberships for a membership fee;
b. providing a reduction in the fees charged by the organization relative to the membership fee to persons purchasing memberships; and
c. refunding at least a portion of the membership fee to the persons purchasing memberships upon withdrawal from the membership.

2. The method as claimed in claim 1, wherein the membership fee is variable, the reduction in the fees charged is equal to 5% to 20% of the membership fee, and 85% and 100% of the membership fee is refunded upon withdrawal fro the membership.

3. The method as claimed in claim 3, wherein the organization is a school and the fees charged by the school comprise tuition.

4. A method for creating an endowment for a school charging tuition comprising the steps of:
a. selling memberships to the endowment to persons related to at least one student for a membership fee;
b. providing a reduction in the tuition to the school charged by the school of 5% to 20% of the tuition to the persons related to at least one student for the at least one student; and
c. refunding at least a portion of the membership fee upon withdrawal from the membership to the persons related to at least one student.

5. The method as claimed in claim 5, wherein the membership fee is sold available in increments of a set dollar amount; the persons related to at least one student are selected from the group consisting of parents, grandparents and guardians of the at least one student; the tuition reduction is available to the persons related to at least one student; and up to 100% of the membership fee is refunded to the persons related to at least one student upon withdrawal from membership to the endowment.
